(19) United States
(12) Patent Application Publication
(10) Pub. No.: US 2024/0222986 A1
(43) Pub. Date: Jul. 4, 2024

(54) POWER SUPPLY CONTROL METHOD AND POWER SUPPLY CONTROL CIRCUIT

(71) Applicant: Lenovo (Beijing) Limited, Beijing (CN)

(72) Inventors: Ming GAO, Beijing (CN); Guofu HUA, Beijing (CN)

(21) Appl. No.: 18/538,572

(22) Filed: Dec. 13, 2023

(30) Foreign Application Priority Data
Dec. 30, 2022 (CN) 202211727185.7

(51) Int. Cl. H02J 7/00

(52) U.S. Cl. CPC H02J 7/0024; H02J 7/00034; H02J 7/0048; H02J 7/007182

(57) ABSTRACT

A power supply control method includes: identifying a power supply mode of a first interface of the electronic device in response to detecting that the electronic device is in a first usage mode; configuring a charging circuit in a battery module of the electronic device to a first charging mode in response to determining that the power supply mode is a first mode, the first mode being used to charge a first battery pack and a second battery pack in the battery module in series; and configuring the charging circuit of the battery module to a second charging mode and charging the first battery pack and the second battery pack in the battery module in the second charging mode in response to a charging capacity of the first battery pack reaching a first set threshold, the first charging mode being different from the second charging mode.

### CROSS-REFERENCES TO RELATED APPLICATION

This application claims priority to Chinese Patent Application No. 202211727185.7 filed on Dec. 30, 2022, the entire content of which is incorporated herein by reference.

### FIELD OF TECHNOLOGY

The present disclosure relates to the field of energy supply control technology and, more specifically, to a power supply control method and a power supply control circuit.

### BACKGROUND

In the conventional series battery solutions, the battery pack includes two cells in series. In order to improve the charging efficiency, switching between series charging and parallel charging are being used. However, there is a tradeoff that needs to be made between charging efficiency and balancing the charging voltage of the battery pack.

### SUMMARY

One aspect of this disclosure provides a power supply control method. The power supply control method includes identifying a power supply mode of a first interface of the electronic device in response to detecting that the electronic device is in a first usage mode; configuring a charging circuit in a battery module of the electronic device to a first charging mode in response to determining that the power supply mode is a first mode; and configuring the charging circuit of the battery module to a second charging mode and charging a first battery pack and a second battery pack in the battery module in the second charging mode in response to a charging capacity of the first battery pack reaching a first set threshold. The first mode is used to charge the first battery pack and the second battery pack in the battery module in series, and the first charging mode is different from the second charging mode.

Another aspect of this disclosure provides a power supply control circuit. The power supply control circuit includes a battery module, the battery module including a first battery pack and a second battery pack; a gating circuit, the gating circuit being respectively connected to the first battery pack and the second battery pack; and a controller connected to the gating circuit. The controller is configured to: detect a usage mode of the electronic device, and identify a power supply mode of a first interface of the electronic device in response to determining that the electronic device is in a first usage mode; configure the gating circuit for a charging circuit of the battery module to be in a first charging mode in response to determining the power supply mode is a first mode, the first charging mode being used to charge the first battery pack and the second battery pack in the battery module in series; and configure the gating circuit for the charging circuit of the battery module to be in a second charging mode, and charge the first battery pack and the second battery pack in the battery module in the second charging mode in response to a charging capacity of the first battery pack reaching a first set threshold, the first charging mode being different from the second charging mode.

### BRIEF DESCRIPTION OF THE DRAWINGS

The following drawings are merely examples for illustrative purposes according to various disclosed embodiments and are not intended to limit the scope of the present disclosure.

FIG. 1 is a flowchart of a power supply control method according to an embodiment of the present disclosure.

FIG. 2 is a flowchart of the power supply control method according to an embodiment of the present disclosure.

FIG. 3 is a flowchart of the power supply control method according to an embodiment of the present disclosure.

FIG. 4 is a schematic structural diagram of a power supply control circuit according to an embodiment of the present disclosure.

FIG. 5 is a schematic diagram of single batteries discharging in parallel according to an embodiment of the present disclosure.

FIG. 6 is a schematic diagram of single batteries charging in series according to an embodiment of the present disclosure.

FIG. 7 is a schematic diagram of single batteries battery charging in parallel according to an embodiment of the present disclosure.

FIG. 8 is a schematic diagram of single batteries battery charging in parallel according to an embodiment of the present disclosure.

FIG. 9 is a schematic diagram of parallel discharging applicable to a battery pack of two series-connected batteries according to an embodiment of the present disclosure.

FIG. 10 is a schematic diagram of series pass-through charging applicable to the battery pack of two series-connected batteries according to an embodiment of the present disclosure.

FIG. 11 is a schematic structural diagram of parallel pass-through charging applicable to the battery pack of two series-connected batteries according to an embodiment of the present disclosure.

FIG. 12 is a schematic structural diagram of parallel pass-through charging applicable to the battery pack of two series-connected batteries according to an embodiment of the present disclosure.

FIG. 13 is a schematic diagram of parallel switch charging applicable to the battery pack of two series-connected batteries according to an embodiment of the present disclosure.

### DETAILED DESCRIPTION

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

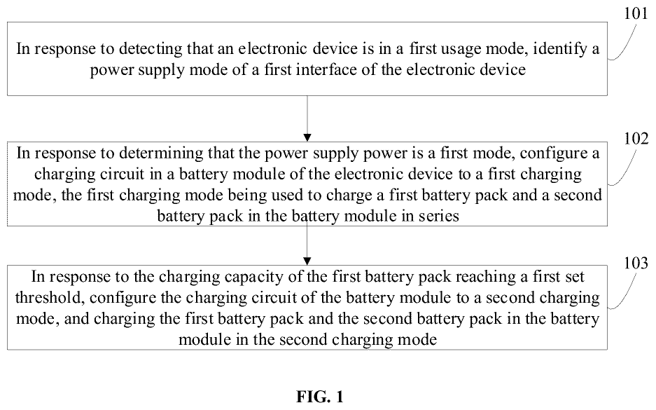

FIG. 1 is a flowchart of a power supply control method according to an embodiment of the present disclosure. The method will be described in detail below.

101, in response to detecting that an electronic device is in a first usage mode, identifying a power supply mode of a first interface of the electronic device.

At present, in order to improve the battery life of electronic devices, multiple batteries are generally provided as working power sources. Multiple batteries of electronic devices also support fast charging of batteries. For example, for an electronic device with two batteries, the two batteries can be charged in series or in parallel by adjusting the charging circuit. However, the charging speed is greatly affected when the charging mode of the electronic device switches back and forth between series charging and parallel charging.

In the embodiments of the present disclosure, the first usage mode can be referred to as a usage mode in which the electronic device is being powered, that is, a usage mode in which the electronic device is being charged.

When the electronic device is in the first usage mode, the power supply mode of the first interface of the electronic device can be identified. The power supply modes may include charging methods supported by electronic devices, such as fast charging, normal charging, series charging, and parallel charging.

In the embodiments of the present disclosure, multiple charging circuits can be provided for multiple sets of batteries in the electronic device such that corresponding charging circuits can be configured to adapt to the current charging method, thereby realizing fast charging of batteries in the electronic device.

102, in response to determining that the power supply power is a first mode, configuring a charging circuit in a battery module of the electronic device to a first charging mode, the first charging mode being used to charge a first battery pack and a second battery pack in the battery module in series.

In the embodiments of the present disclosure, when it is determined that the power supply mode is the first mode, the charging circuit of the battery module of the electronic device can be configured to the first charging mode. The first charging mode may be to charge the battery modules in the electronic device in series. In the embodiments of the present disclosure, the battery module of the electronic device may include at least two battery packs, and the electronic device may also include a corresponding charging circuit for the battery module such that the battery module can support at least two or more charging modes. By determining the power supply mode of the electronic device and selecting the charging circuit corresponding to the functional mode that can charge the battery module of the electronic device, the charging of the electronic device can be completed more efficiently.

103, in response to the charging capacity of the first battery pack reaching a first set threshold, configuring the charging circuit of the battery module to a second charging mode, and charging the first battery pack and the second battery pack in the battery module in the second charging mode.

In some embodiments, the first charging mode may be different from the second charging mode. When the first charging mode is a series charging mode, the second charging mode may be a parallel charging mode. Or, the second charging mode may use a round robin method to separately charge the first battery pack and the second battery pack in the battery module. For example, the first battery pack may be charged for 5 minutes, and then the second battery pack may be charged for 5 minutes, until both the first battery pack and the second battery pack are charged to a corresponding level, or until the circuit of the second charging mode is switched, or the charger is pulled out, etc.

In the embodiments of the present disclosure, based on the power supply mode, by charging the first battery pack and the second battery pack in series, one battery can be prioritized for fast charging to a preset threshold. For example, one battery can be fully charged first and then the charging mode can be switched without considering the voltage imbalance between the two battery packs, thereby increasing the series charging time, reducing the total charging time, and improving charging efficiency.

In the embodiments of the present disclosure, the first set threshold may be 100% or 80% corresponding to full charge.

Consistent with the present disclosure, the first battery pack and the second battery pack in the battery module can be charged in series through the first charging mode. When it is determined that the charging capacity of the first battery pack reaches the first set threshold, the charging circuit of the battery module can be configured to the second charging mode. The first battery pack and the second battery pack in the battery module can be charged in the second charging mode, which reduces the total charging time and improves the charging efficiency.

In some embodiments, configuring the charging circuit as the second charging mode may include configuring the power supply circuit of the battery module as a first power supply mode, the first power supply mode prioritizing the first battery pack in the battery module as the operating power source of the electronic device. When the charging circuit is configured as the second charging mode, since the first battery pack has been charged to the first set threshold, at this time, regardless of the usage mode of the electronic device, or whether the second battery pack is in the charging mode, or how the second battery pack is being charged, the first battery pack may be directly used as the operating power source of the electronic device. At this time, the power output circuit of the first battery pack may need to be adjusted such that it can be enabled as the operating power source of the electronic device.

In some embodiments, since the first battery pack is prioritized to be charged to the first set threshold, when the series charging is stopped, the first battery pack is given priority as the operating power source of the electronic device to achieve voltage balance between the two battery packs.

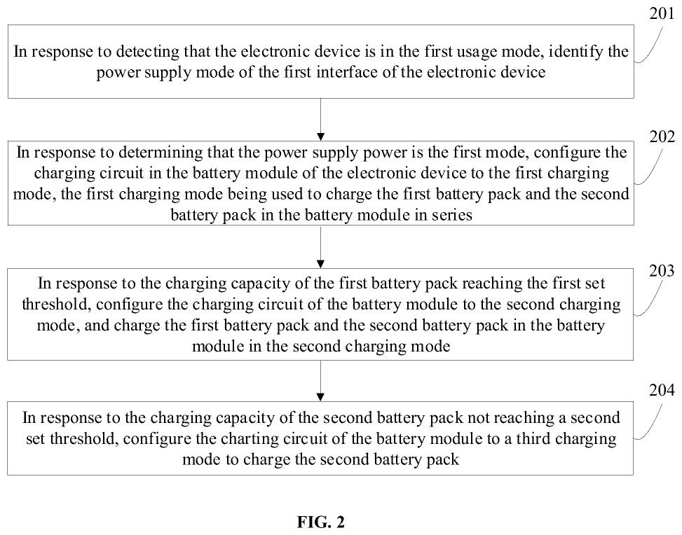

FIG. 2 is a flowchart of the power supply control method according to an embodiment of the present disclosure. The method will be described in detail below.

201, in response to detecting that the electronic device is in the first usage mode, identifying the power supply mode of the first interface of the electronic device.

202, in response to determining that the power supply power is the first mode, configuring the charging circuit in the battery module of the electronic device to the first charging mode, the first charging mode being used to charge the first battery pack and the second battery pack in the battery module in series.

203, in response to the charging capacity of the first battery pack reaching the first set threshold, configuring the charging circuit of the battery module to the second charging mode, and charging the first battery pack and the second battery pack in the battery module in the second charging mode.

The processes at 201-203 are consistent with the processes at 101-103. For details, reference can be made to the relevant description in the foregoing embodiments.

204, in response to the charging capacity of the second battery pack not reaching a second set threshold, configuring the charting circuit of the battery module to a third charging mode to charge the second battery pack.

In some embodiments, the third charging mode may be an independent charging mode of the second battery pack in the battery module. At this time, since the first battery pack has been charged to the first set threshold, if it is determined that the second battery pack has not reached the second set threshold, separate charging of the second battery pack can be started.

Consistent with the present disclosure, the second battery pack can be charged separately by adjusting the charging circuit in the battery module. It should be noted that, although the battery packs in the embodiments of the present disclosure are being referenced as a battery pack, it may only include a single battery, or it may be a battery pack in which multiple batteries are connected in series or in parallel. It should also be noted that the second set threshold may be 100%, 90%, 85%, 80%, 75%, etc. of the full charge. When the second battery pack includes more than two batteries, the power of the second battery pack reaching the second set threshold may be that the power of two or more batteries in the second battery pack reaches the second set threshold.

In some embodiments, when the second battery pack is being charged through the third charging mode, the controller in the electronic device may also be used to determine the voltage of each battery pack in the battery module, and use the battery pack with the higher voltage as the operating power source of the electronic device. That is, when it is determined that the voltage of the first battery pack is lower than the voltage of the second battery pack, the power supply of the electronic device may be switched to the second battery pack. Of course, in some embodiments, the first battery pack may always be used to the power source of the electronic device.

Consistent with the present disclosure, by charging the first battery pack and the second battery pack in series, the voltage imbalance between the two battery packs can be ignored, thereby increasing the series charging time, reducing the total charging time, and improving the charging efficiency. When the charging capacity of the first battery pack reaches the first set threshold, the first battery pack and the second battery pack can be charged in parallel using the second charging mode, or the second battery pack can be charged in the third charging mode alone such that the second battery pack can be quickly charged to reach the second set power threshold.

FIG. 3 is a flowchart of the power supply control method according to an embodiment of the present disclosure. The method will be described in detail below.

301, in response to detecting that the electronic device is in the first usage mode, identifying the power supply mode of the first interface of the electronic device.

302, in response to determining that the power supply power is the first mode, configuring the charging circuit in the battery module of the electronic device to the first charging mode, the first charging mode being used to charge the first battery pack and the second battery pack in the battery module in series.

303, in response to the charging capacity of the first battery pack reaching the first set threshold, configuring the charging circuit of the battery module to the second charging mode, and charging the first battery pack and the second battery pack in the battery module in the second charging mode.

304, in response to the charging capacity of the second battery pack not reaching the second set threshold, configuring the charting circuit of the battery module to the third charging mode to charge the second battery pack.

The processes at 301-304 are consistent with the processes at 201-203. For details, reference can be made to the relevant description in the foregoing embodiments.

305, in response to determining the power supply mode is the second mode, configuring the charging circuit of the battery module to a fourth charging mode, the fourth charging mode being used to alternately charge the first battery pack and the second battery pack in the battery module.

In some embodiments, the second power supply mode may be another mode of fast charging, which can only provide an appropriate charging voltage for a single battery pack and is not sufficient to support series charging of multiple battery packs, but can support fact charging of a limited number of battery packs. For example, when the first battery pack includes more than two batteries connected in series and the second battery pack also includes more than two batteries connected in series, in this case, the second power supply mode may not support series charging of the first battery pack and the second battery pack. At this time, the charging circuit of the of the battery module can be configured as the fourth charging mode. The fourth charging mode can be used to alternately charge the first battery pack and the second battery pack in the battery module. That is, the first battery pack and the second battery pack in the battery module can be alternately charged in a round-robin manner. For example, the first battery pack can be charged for 10 minutes, then the second battery pack can be charged for 10 minutes. The alternation of charging can be continued until both the first battery pack and the second battery pack are fully charged. In some embodiments, in the fourth charging mode, when the first battery pack and the second battery pack are being alternately charged, each battery in the first battery pack may be charged in parallel, or each battery in the second battery pack may be charged in parallel. Alternatively, each battery in the first battery pack may be charged in series, or each battery in the second battery pack may be charged in series.

Consistent with the present disclosure, by alternately charging the first battery pack and the second battery pack through the fourth charging mode, the first battery pack and the second battery pack can quickly reach their set power thresholds respectively, thereby improving charging efficiency of the first battery pack and the second battery pack. After one set of battery packs reaches the set power threshold, the other battery pack can be charged independently such that the remaining battery pack can quickly reach the set power threshold, for example, the power can reach the maximum power, etc.

In some embodiments, based on the foregoing embodiments, the power supply control method may also include: in response to determining that the power supply mode is the third mode, configuring the charging circuit of the battery module of the electronic device to a fifth charging mode. The fifth charging mode may be used to charge the first battery pack and the second battery pack in the battery module in parallel. Here, the third charging mode may be a normal charging mode, that is, the battery module of the electronic device cannot be quickly charged. At this time, the charging circuit of the electronic device needs to be adjusted to normal mode. That is, the charging circuit of the battery module of the electronic device is configured to the fifth charging mode, and the first battery pack and the second battery pack in the battery module are charged in parallel.

In some embodiments, based on the method described above, when it is determined that the electronic device is in a second usage mode (the second usage mode may include a non-charging mode), at this time, in response to detecting that the electronic device is in the second usage mode, the power supply circuit of the battery module may be configured to the second power supply mode. In the second power supply mode, the voltage of the battery packs in the battery module may be periodically detected, and the battery pack with a higher voltage in the battery module may be used as the operating power source of the electronic device. At this time, the voltages of the first battery pack and the second battery pack need to be detected, and the battery pack with the higher voltage needs to be set as the operating power source of the electronic device. Of course, the voltage of the battery pack set as the operating power source of the electronic device may be at least a certain threshold higher than other battery packs, such as 0.2V, 0.3V, etc.

When the voltage of one battery pack in the battery module is higher than the voltage of another battery pack by a certain threshold, switching the batteries from series to parallel may cause safety hazards. By switching the power supply of the electronic device to a battery pack with a higher voltage, rough battery voltage balancing can be performed to avoid safety hazards and improve the safety of the electronic device.

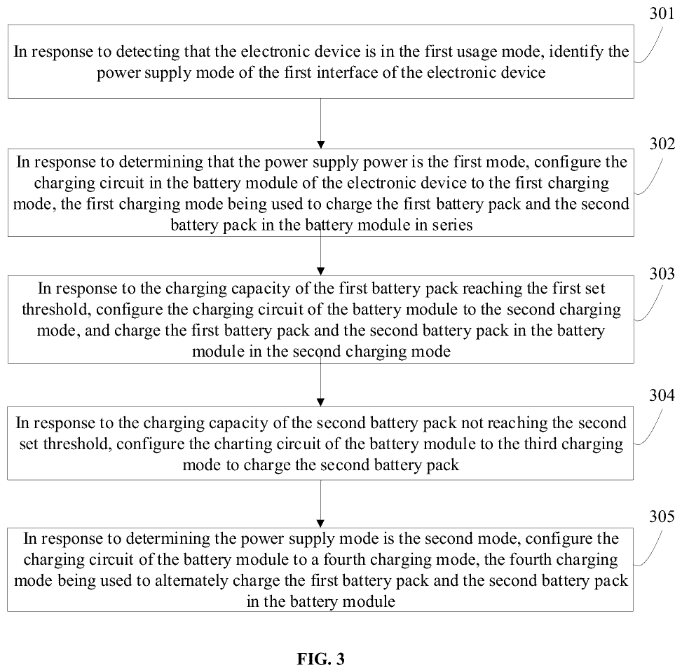

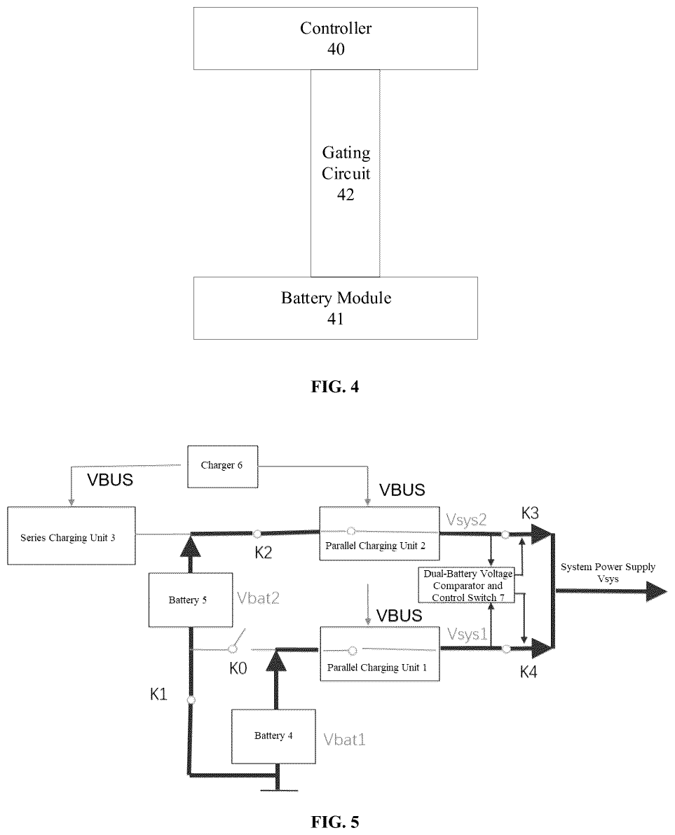

FIG. 4 is a schematic structural diagram of a power supply control circuit according to an embodiment of the present disclosure. The power supply control circuit can be applied to electronic devices. As shown in FIG. 4, the power supply control circuit includes a controller 40, a battery module 41, and a gating circuit 42. The controller 40 is connected with the gating circuit 42. The controller 40 may be configured to: detect the usage mode of the electronic device, determine that the electronic device is in the first usage mode, identify the power supply mode of the first interface of the electronic device; determine the power supply mode as the first mode, configure the gating circuit such that the charging circuit of the battery module is the first charging mode, the first charging mode being used to charge the first battery pack and the second battery pack in the battery module in series; configure the gating circuit when the charging capacity of the first battery pack reaches the first set threshold such that the charging circuit of the battery module uses the second charging mode, charge the first battery pack and the second battery pack using the second charging mode, the first charging mode being different from the second charging mode. The battery module 41 may include at least a first battery pack and a second battery pack. The gating circuit 42 may be respectively connected to the first battery pack and the second battery pack.

In some embodiments, based on the power supply mode, the controller may configure the gating circuit to charge the first battery pack and the second battery pack in series, giving priority to one battery pack to quickly charge the battery pack to a preset threshold. Subsequently, the charging circuit of the battery module may be configured to the second charging mode, and the first battery pack and the second battery pack in the battery module may be charged in the second charging mode, thereby reducing the total charging time and improving charging efficiency.

In the embodiments of the present disclosure, the first set threshold may be 100% or 80% corresponding to full charge.

In some embodiments, when the charging circuit is in the second charging mode, the controller 40 may be further configured to configure the gating circuit 42 such that the power supply circuit of the battery module is in the first power supply mode. The first power supply mode may prioritize the first battery pack in the battery module as the operating power source of the electronic device.

In some embodiments, since the first battery pack is prioritized to be charged to the first set threshold, when the series charging is stopped, the first battery pack is given priority as the operating power source of the electronic device to achieve voltage balance between the two battery packs.

In some embodiments, the first battery pack may include more than two batteries connected in series and the second battery pack may also include more than two batteries connected in series, and the controller 40 may be further configured to configure the gating circuit 42 such that the charging circuit of the battery module is in the third charging mode to charge the second battery pack in the battery module when the charging capacity of the second battery pack does not reach the second set threshold.

Consistent with the present disclosure, by charging the first battery pack and the second battery pack in series, the voltage imbalance between the two battery packs can be ignored, thereby increasing the series charging time, reducing the total charging time, and improving the charging efficiency. When the charging capacity of the first battery pack reaches the first set threshold, the first battery pack and the second battery pack can be charged in parallel using the second charging mode, or the second battery pack can be charged in the third charging mode alone such that the second battery pack can be quickly charged to reach the second set power threshold.

In some embodiments, the controller 40 may be further configured to configure the gating circuit 42 such that the charging circuit of the battery module is in the fourth charging mode when it is determined that the power supply mode is the second mode, the fourth charging mode being used to alternately charge the first battery pack and the second battery pack in the battery module.

Consistent with the present disclosure, by alternately charging the first battery pack and the second battery pack through the fourth charging mode, the first battery pack and the second battery pack can quickly reach their set power thresholds respectively, thereby improving charging efficiency of the first battery pack and the second battery pack. After one set of battery packs reaches the set power threshold, the other battery pack can be charged independently such that the remaining battery pack can quickly reach the set power threshold, for example, the power can reach the maximum power, etc.

In some embodiments, the controller 40 may be further configured to configure the gating circuit 42 such that the charging circuit of the battery module is in the fifth charging mode when it is determined that the power supply mode is the third mode, the fifth charging mode being used to charge the first battery pack and the second battery pack in the battery module in parallel. Here, the third charging mode may be a normal charging mode, that is, the battery module of the electronic device cannot be quickly charged. At this time, the charging circuit of the electronic device needs to be adjusted to normal mode. That is, the charging circuit of the battery module of the electronic device is configured to the fifth charging mode, and the first battery pack and the second battery pack in the battery module are charged in parallel.

When the voltage of one battery pack in the battery module is higher than the voltage of another battery pack by a certain threshold, switching the batteries from series to parallel may cause safety hazards. By switching the power supply of the electronic device to a battery pack with a higher voltage, rough battery voltage balancing can be performed to avoid safety hazards and improve the safety of the electronic device.

The specific implementation of the technical solutions of the embodiments of the present disclosure will be further described below through the specific charging and power supply connection circuits of the battery module.

FIG. 5 is a schematic diagram of single batteries discharging in parallel according to an embodiment of the present disclosure. As shown in FIG. 5, in this embodiment, the battery in the battery pack is a single battery, and the specific implementation of each battery and the gating circuit is shown in FIG. 5. The control circuit shown in FIG. 5 is suitable for the situation where the battery pack in a single-cell battery. If a charger 6 is not inserted, at this time, the electronic device may be in the second usage mode. The controller of the electronic device may enable a parallel charging unit 1 and a parallel charging unit 2 by default, only enable the path between the internal Vbat and Vsys, disable the charging function, control the disconnect switch K0, and turn on the switches K1 and K2. A dual-battery voltage comparator and control switch 7 may automatically control the tuning on and off the switches K3 and K4, switch the power supply between the two battery groups, namely a battery 4 and a battery 5, and maintain the voltage balance of the two batteries. At this time, the series charging unit 3 in FIG. 5 may be disabled. The switching power supply here may use the battery with a higher voltage as the power supply for the electronic device when it is detected that the voltage difference between the two batteries exceeds a first threshold, such as 0.3V.

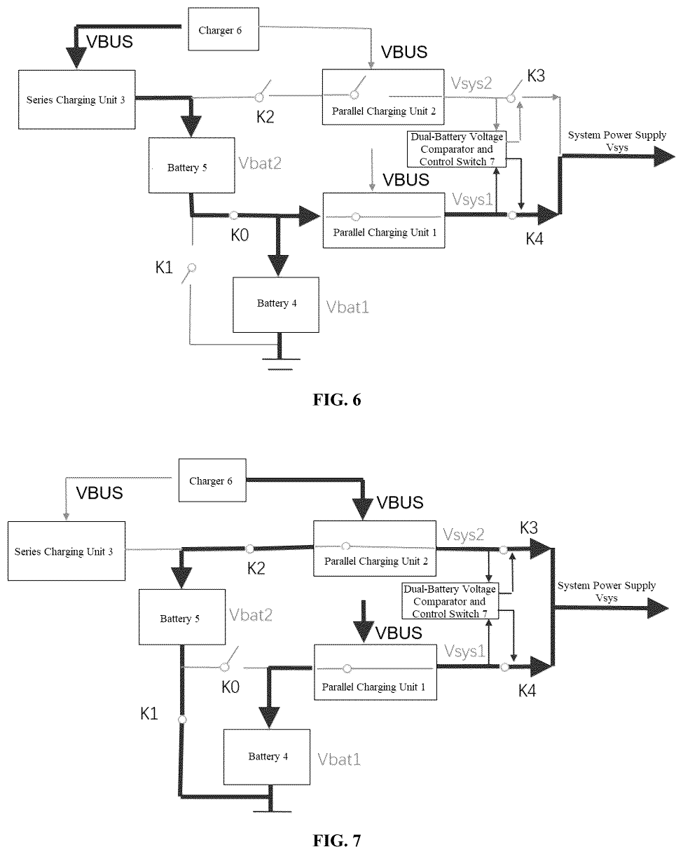

FIG. 6 is a schematic diagram of single batteries charging in series according to an embodiment of the present disclosure. As shown in FIG. 6, in this embodiment, the battery in the battery pack is a single battery, and the specific implementation of each battery and the gating circuit is shown in FIG. 6. If the inserted charger 6 is recognized as a high-voltage fast charging charger suitable for series charging, such as USB-PD, quick charge (QC), pump express (PE), and other high-voltage fast charging protocol chargers, the parallel charging unit 2 may be controlled to stop working completely, and the parallel charging unit 1 may only conduct the internal metal-oxide-semiconductor field-effect transistor (MOSFET) path between Vbat and Vsys, but its charging function may be turned off. The switches K1 and K2 may be controlled to be turned off, the switch K0 may be turned on to apply for high-voltage charging voltage and current from the charger, the series charging unit 3 may be turned on, the series charging path for the battery 4 and the battery 5 may be opened such that series charging can be performed for the battery 4 and the battery 5 until the battery 5 is charged to the first threshold, such as 100% or 80% of full charge.

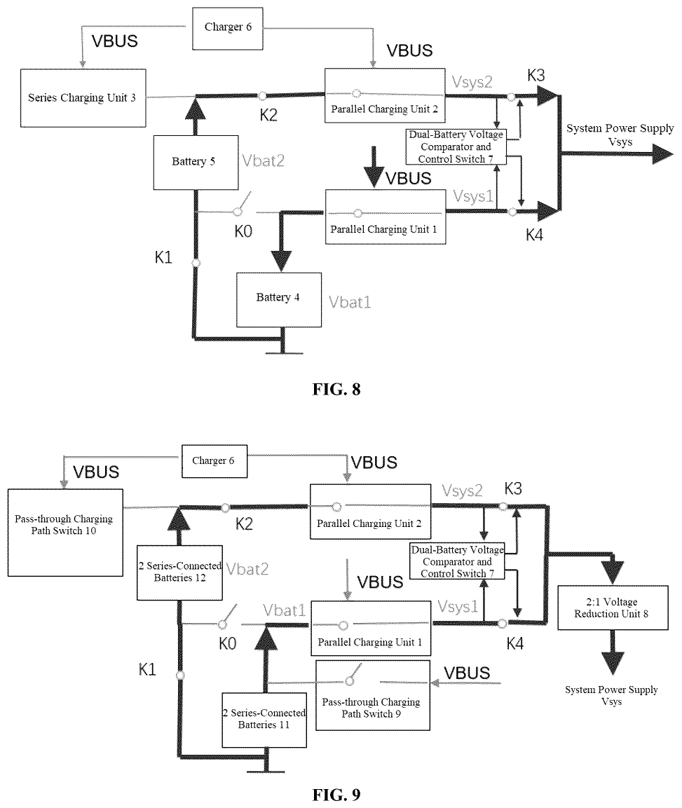

FIG. 7 is a schematic diagram of single batteries charging in parallel according to an embodiment of the present disclosure. As shown in FIG. 7, in this embodiment, the battery in the battery pack is a single battery, and the specific implementation of each battery and the gating circuit is shown in FIG. 7. The charger 6 may be first requested to reduce the voltage to a normal charger (mainly referring to 5V charging protocols such as BC 1.2), the series charging unit 3 and the switch K0 may be turned off, the switches K1 and K2 may be enabled, and the parallel charging unit 1 parallel charging unit 2 may also be enabled. At this time, the parallel charging and power supply path can be turned on, and if the battery 4 is also fully charged, the charging can be ended. FIG. 8 is a schematic diagram of single batteries battery charging in parallel according to an embodiment of the present disclosure. As shown in FIG. 8, if the system load is relatively large during the foregoing series charging process such that single battery 4 is not fully charged, the parallel charging unit 1 may continue to be used independently to charge the battery 4. The dual-battery voltage comparator and control switch 7 can cause the system to prioritize the discharge of the battery 5, and eventually achieve the voltage balance and full charging of the two batteries. in the embodiments of the present disclosure, by prioritizing the battery 5 with larger power and higher voltage as the operating power supply of the electronic device, fast charging of the battery 4 can be ensured such that the battery 4 and the battery 5 can quickly meet the charging requirements.

FIG. 9 is a schematic diagram of parallel discharging applicable to a battery pack of two series-connected batteries according to an embodiment of the present disclosure. As shown in FIG. 9, the specific gating circuit connection diagram of each battery pack according to an embodiment of the present disclosure is shown. If the charger 6 is not inserted, the parallel charging unit 1 and the parallel charging unit 2 may be enabled by default, and only the MOSFET between the internal Vbat and Vsys of the parallel charging unit 1 and the parallel charging unit 2 may be turned on, the charging function may not be enabled, the switch K0 may be turned off, and switches K1 and K2 may be turned on. The dual-battery voltage comparator and control switch 7 may automatically control the one and off of the switches K3 and K4, switch the power supply between the two batteries, namely two series-connected batteries 11 and two series-connected batteries 12, and maintain the voltage balance of the two battery packs. At this time, a pass-through charging path switch 9 and a pass-through charging path switch 10 in FIG. 9 may not be enabled. When an electronic device is powered by the two series-connected batteries 11 or the two series-connected batteries 12, a 2:1 voltage reduction unit 8 may need to be enabled for voltage reduction.

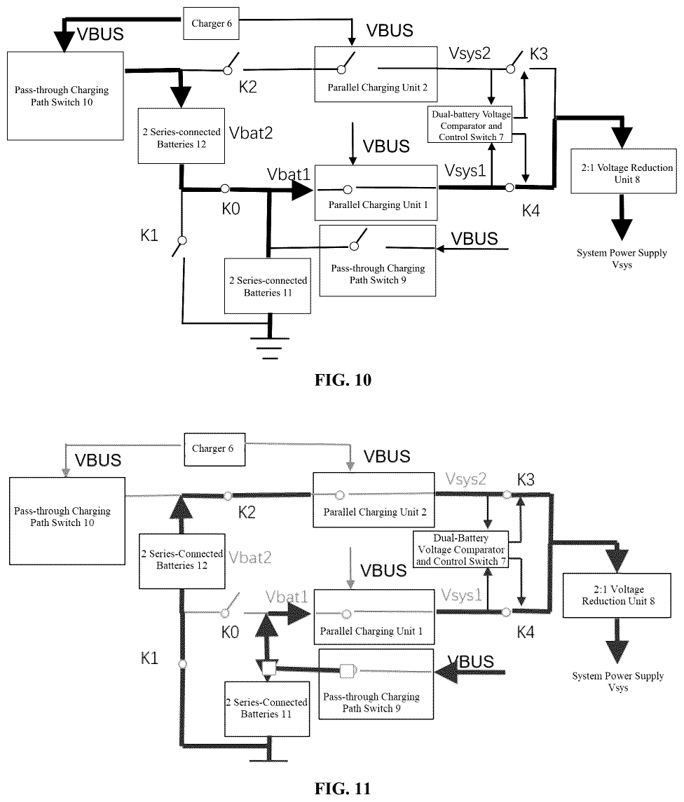

FIG. 10 is a schematic diagram of series pass-through charging applicable to the battery pack of two series-connected batteries according to an embodiment of the present disclosure. As shown in FIG. 10, if the charger 6 currently inserted into the electronic device is a 4:4 finely regulated high-voltage fast charging charger, such as PD3.0 QC4.0, PE5.0 and other chargers that support fast charging protocols, then pass-through series charging may be performed on the two series-connected batteries 11 or the two series-connected batteries 12 for a total of four series-connected batteries. At this time, the switches k1 and K2 may need to be controlled to be off, switch K0 may be turned on, parallel charging unit 2 may need to completely stop working. For the parallel charging unit 1, only its internal Vbat to Vsys path MOSFET may be turned on, but its charging function may be turned off. The charger 6 may be requested for a high-voltage direct charging voltage and current suitable for the two series-connected batteries 11 and the two series-connected batteries 12, the pass-through charging path switch 10 may be enabled, and series charging path may be executed until the two series-connected batteries 12 are fully charged.

If the two series-connected batteries 11 are also fully charged, then the charging can be ended. FIG. 11 is a schematic structural diagram of parallel pass-through charging applicable to the battery pack of two series-connected batteries according to an embodiment of the present disclosure. As shown in FIG. 11, if the system load is relatively large during the foregoing series charging process such that two series-connected batteries 11 are not fully charged, the pass-through charging path switch 9 may continue to be used independently to charge the two series-connected batteries 11. First, the pass-through charging path switch 10 may be turned off, the switch K0 may be turned off, switches K1 and K2 may be turned off, and the parallel charging unit 1 and parallel charging unit 2 may be enabled (only the internal Vbat to Vsys MOSFET path may be turned on, but the charging function may not be enabled). A request may be made to the charger 6 for a voltage and current suitable for direct charging of the two series-connected batteries 11, and the pass-through charging path switch 9 may be enabled. At this time, the parallel pass-through charging and power supply path may be turned on. The dual-battery control circuit of the embodiments of the present disclosure can enable the system to prioritize the discharge of the two series-connected batteries 12 and eventually achieve a voltage balance and full charge of the two battery packs.

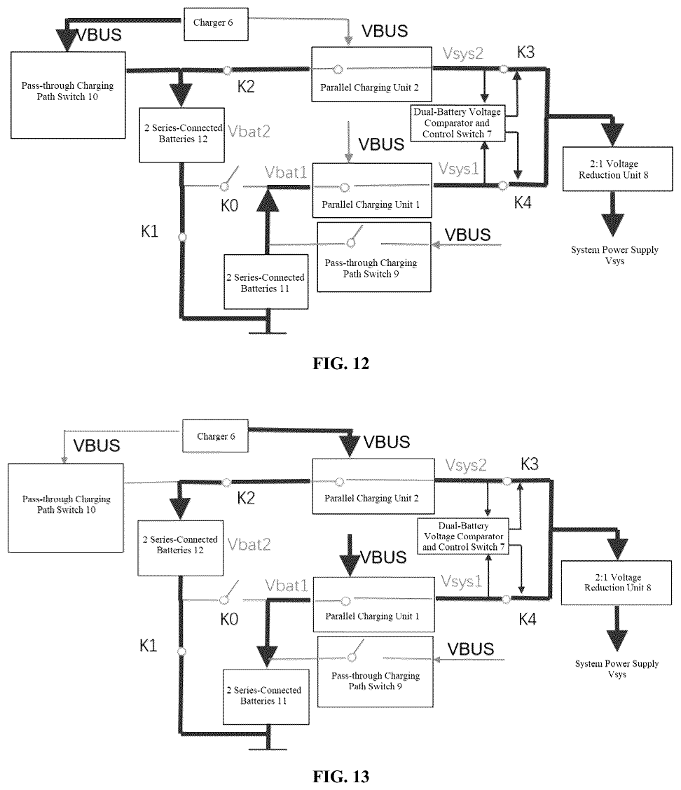

FIG. 12 is a schematic structural diagram of parallel pass-through charging applicable to the battery pack of two series-connected batteries according to an embodiment of the present disclosure. As shown in FIG. 12, if the two series-connected batteries 12 are being discharged while the two series-connected batteries 11 are being charged separately, the two series-connected batteries 12 may not be fully charged when the two series-connected batteries 11 are fully charged. In this case, the pass-through charging path switch 9 may be turned off, a request may be made to the charger 6 for a voltage and current suitable for direct charging of the two series-connected batteries 12, and the pass-through charging path switch 10 may be turned on to separately perform parallel direct charging of the two series-connected batteries 12.

FIG. 13 is a schematic diagram of parallel switch charging applicable to the battery pack of two series-connected batteries according to an embodiment of the present disclosure. As shown in FIG. 13, if the inserted charger 6 is a 2:2 finely regulated high-voltage charger (2:2 means that the maximum output of the charger can each about 10V, and can directly charge two series-connected batteries), then the two series-connected batteries 11 and the two series-connected batteries 12 may be directly charged until both battery packs are fully charged. If the inserted charger 6 is not a finely regulated voltage charger (such as PD2.0, QC2.0, QC3.0, PE2.0 and other non-finely regulated voltage charger or ordinary BC1.2 5V charger), the switch K0 may be turned off, the switches K1 and K2 may be turned on, and the parallel charging unit 1 and parallel charging unit 2 may be enabled to perform parallel switch charging.

In the present disclosure, the terms “comprising,” “including” or any other variation thereof are intended to encompass a non-exclusive inclusion such that a process, method, article or device comprising a list of elements includes not only those elements, but also others not expressly listed elements, or also include elements inherent to such a process, method, article or apparatus. Without further limitation, an element qualified by the phrase “comprising a . . . ” does not preclude the presence of additional identical elements in a process, method, article or apparatus that includes the element.

In the embodiments provided in the present disclosure, it should be understood that the disclosed system, device, and method may be implemented in other ways. For example, the device embodiments described above are only illustrative. For example, the division of the units is only a logical function division, and there may be other divisions in actual implementation. For example, multiple units or components may be combined or can be integrated into another system, or some features can be ignored or not implemented. In addition, the displayed or discussed mutual coupling or direct coupling or communication connection may be indirect coupling or communication connection through some interfaces, devices or units, and may also be electrical, mechanical or other forms of connection.

The units described as separate components may or may not be physically separated, and the components displayed as units may or may not be physical units, that is, they may be located in one place, or they may be distributed on multiple network units. Some or all of the units may be selected according to actual needs to achieve the objectives of the solutions of the embodiments of the present disclosure.

In addition, the functional units in the various embodiments of the present disclosure may be integrated into one processing unit, or each unit may exist alone physically, or two or more units may be integrated into one unit. The above-mentioned integrated unit can be implemented in the form of hardware or software functional unit.

A person of ordinary skill in the art can be aware that all or some of the processes in the method embodiments of the present disclosure can be implemented by hardware related to the program instructions. The program may be stored in a computer-readable storage medium. When the program is executed, the processes of the method embodiments may be executed. The aforementioned storage medium includes: a mobile storage medium, a read-only memory (ROM), a magnetic disk, an optical disk, or another medium that can store program codes.

When the integrated unit is implemented in the form of a software functional unit and sold or used as an independent product, it can be stored in a computer-readable storage medium. Based on this understanding, all or part of the technical solution can be embodied in the form of a software product. The computer software product is stored in a storage medium, and includes several instructions to enable a computer device (which may be a personal computer, a server, or a network device, etc.) to perform all or some of the processes of the method described in each embodiment of the present disclosure. The aforementioned storage medium includes: a mobile storage medium, a read-only memory (ROM), a magnetic disk, an optical disk, or another medium that can store program codes.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the disclosure. Thus, while the present disclosure has been described in detail with reference to the above described embodiments, the present disclosure is not limited to the above described embodiments, but may be embodied in other equivalent forms without departing from the scope of the present disclosure.

What is claimed is:

1. A power supply control method, applicable to an electronic device, comprising:
identifying a power supply mode of a first interface of the electronic device in response to detecting that the electronic device is in a first usage mode;
configuring a charging circuit in a battery module of the electronic device to a first charging mode in response to determining that the power supply mode is a first mode, the first mode being used to charge a first battery pack and a second battery pack in the battery module in series; and
configuring the charging circuit of the battery module to a second charging mode and charging the first battery pack and the second battery pack in the battery module in the second charging mode in response to a charging capacity of the first battery pack reaching a first set threshold, the first charging mode being different from the second charging mode.

2. The power supply control method of claim 1, wherein configuring the charging circuit to the second charging mode further includes:
configuring a power supply circuit of the battery module to a first power supply mode, the first power supply mode prioritizing the first battery pack in the battery module as an operating power source of the electronic device.

3. The power supply control method of claim 1 further comprising:
configuring the charging circuit of the battery module to a third charging mode to charge the second battery pack in response to the charging capacity of the second battery pack not reaching a second preset threshold.

4. The power supply control method of claim 3 further comprising:
determining a voltage of each battery pack in the battery module and using the battery pack with a higher voltage as the operating power source of the electronic device.

5. The power supply control method of claim 3, wherein:
the first battery pack includes more than two batteries connected in series, and the second battery pack includes more than two batteries connected in series;
the method further comprising:
configuring the charging circuit of the battery module to a fourth charging mode in response to determining that the power supply mode is a second mode, the fourth charging mode being used to alternately charge the first battery pack and the second battery pack in the battery module.

6. The power supply control method of claim 1 further comprising:
configuring the charging circuit of the battery module to a fifth charging mode in response to determining that the power supply mode is a third mode, the fifth charging mode being used to charge the first battery pack and the second battery pack in the battery module in parallel.

7. The power supply control method of claim 1 further comprising:
configuring the power supply circuit of the battery module to a second power supply mode in response to detecting that the electronic device is in a second usage mode, the second power supply mode periodically detecting the voltage of the battery pack in the battery module, and using the battery pack with the higher voltage in the battery module as the operating power source of the electronic device.

8. A power supply control circuit, applicable to an electronic device, comprising:
a battery module, the battery module including a first battery pack and a second battery pack;
a gating circuit, the gating circuit being respectively connected to the first battery pack and the second battery pack; and
a controller connected to the gating circuit, wherein the controller is configured to:
detect a usage mode of the electronic device, and identify a power supply mode of a first interface of the electronic device in response to determining that the electronic device is in a first usage mode;
configure the gating circuit for a charging circuit of the battery module to be in a first charging mode in response to determining the power supply mode is a first mode, the first charging mode being used to charge the first battery pack and the second battery pack in the battery module in series; and
configure the gating circuit for the charging circuit of the battery module to be in a second charging mode, and charge the first battery pack and the second battery pack in the battery module in the second charging mode in response to a charging capacity of the first battery pack reaching a first preset threshold, the first charging mode being different from the second charging mode.

9. The power supply control circuit of claim 8, wherein the controller is further configured to:
configure the gating circuit for a power supply circuit of the battery module to a first power supply mode in response to the charging circuit being in the second charging mode, the first power supply mode prioritizing the first battery pack in the battery module as an operating power source of the electronic device.

10. The power supply control circuit of claim 9, wherein:
the first battery pack includes more than two batteries connected in series, and the second battery pack includes more than two batteries connected in series; and
the controller is further configured to:
configure the gating circuit for the charging circuit of the battery module to be in a third charging mode to charge the second battery pack in the battery module in response to the charging capacity of the second battery pack not reaching a second set threshold.

11. The power supply control circuit of claim 10, wherein the controller is further configured to:
configure the gating circuit for the charging circuit of the battery module to be in a fourth charging mode in response to determining that the power supply mode is a second mode, the fourth charging mode being used to alternately charge the first battery pack and the second battery pack in the battery module.

12. The power supply control circuit of claim 8, wherein the controller is further configured to:
configure the gating circuit for the charging circuit of the battery module to be in a fifth charging mode in response to determining that the power supply mode is a third mode, the fifth charging mode being used to charge the first battery pack and the second battery pack in the battery module in parallel.

13. A non-transitory computer-readable storage medium for controlling power supply, comprising instructions stored thereon, that when executed by one or more processors, perform a method for controlling power supply comprising:
identifying a power supply mode of a first interface of the electronic device in response to detecting that the electronic device is in a first usage mode;
configuring a charging circuit in a battery module of the electronic device to a first charging mode in response to determining that the power supply mode is a first mode, the first mode being used to charge a first battery pack and a second battery pack in the battery module in series; and
configuring the charging circuit of the battery module to a second charging mode and charging the first battery pack and the second battery pack in the battery module in the second charging mode in response to a charging capacity of the first battery pack reaching a first set threshold, the first charging mode being different from the second charging mode.

14. The non-transitory computer-readable storage medium of claim 13, wherein configuring the charging circuit to the second charging mode also includes:
configuring a power supply circuit of the battery module to a first power supply mode, the first power supply mode prioritizing the first battery pack in the battery module as an operating power source of the electronic device.

15. The non-transitory computer-readable storage medium of claim 13, the method further comprising:
configuring the charging circuit of the battery module to a third charging mode to charge the second battery pack in response to the charging capacity of the second battery pack not reaching a second set threshold.

16. The non-transitory computer-readable storage medium of claim 15, the method further comprising:
determining a voltage of each battery pack in the battery module and using the battery pack with a higher voltage as the operating power source of the electronic device.

17. The non-transitory computer-readable storage medium of claim 15, wherein:
the first battery pack includes more than two batteries connected in series, and the second battery pack includes more than two batteries connected in series;
the method further comprising:
configuring the charging circuit of the battery module to a fourth charging mode in response to determining that the power supply mode is a second mode, the fourth charging mode being used to alternately charge the first battery pack and the second battery pack in the battery module.

18. The non-transitory computer-readable storage medium of claim 13, the method further comprising:
configuring the charging circuit of the battery module to a fifth charging mode in response to determining that the power supply mode is a third mode, the fifth charging mode being used to charge the first battery pack and the second battery pack in the battery module in parallel.

19. The non-transitory computer-readable storage medium of claim 13, the method further comprising:
configuring the power supply circuit of the battery module to a second power supply mode in response to detecting that the electronic device is in a second usage mode, the second power supply mode periodically detecting the voltage of the battery pack in the battery module, and using the battery pack with the higher voltage in the battery module as the operating power source of the electronic device.
